(19) United States
(12) Patent Application Publication
(10) Pub. No.: US 2008/0109712 A1
(43) Pub. Date: May 8, 2008

(54) METHOD, SYSTEM, AND PROGRAM PRODUCT SUPPORTING AUTOMATIC SUBSTITUTION OF A TEXTUAL STRING FOR A URL WITHIN A DOCUMENT

(76) Inventors: GERALD F. McBrearty, Austin, TX (US); Shawn P. Mullen, Buda, TX (US); Jessica K. Murillo, Round Rock, TX (US); Johnny Meng-Han Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/556,793

(22) Filed: Nov. 6, 2006

(51) Int. Cl. G06F 17/00

(52) U.S. Cl. 715/208

(57) ABSTRACT

A method of data processing includes detecting insertion of a uniform resource locator (URL) into text of a document of an application program. In response to detecting insertion of the URL, a web page corresponding to the URL is accessed, and a title of the web page is determined. The URL is then replaced with a textual string derived from the title in place of the URL in the text of the document.

### BACKGROUND OF THE INVENTION

1. Technical Field

The present invention relates in general to computers and other data processing systems and in particular to application programs. Still more particularly, the present invention relates to an improved method, system and program product supporting the substitution of a textual string for a uniform resource locator (URL) within a document.

2. Description of the Related Art

An application program is a software program that utilizes computer resources to perform one or more specific tasks for a user. Application programs often employ a graphical user interface (GUI), which presents graphical components and associated textual identifiers to a user via a display device and enables a user to interact with a computer through the manipulation of the graphical components. A uniform resource locator (URL) is a compact string of characters used to identify a resource on a computer network and its primary access mechanism (i.e., its network location). In relation to the World Wide Web, a URL provides a means for an application program, such as a browser, to obtain a representation of a resource by describing the location of the resource on the Internet.

Conventional application programs, such as word processors and email programs, are able to recognize the inclusion of one or more URLs into the text of a document. Once the application program senses the inclusion of a particular leading string (e.g., “http://” or which typically indicates a scheme name, the application program converts the raw URL string into a clickable link (typically composed of the underlined URL text), such that a user may employ a pointing device within the GUI to access the resource identified by the URL. However, most raw URL strings typically include numbers, abbreviations, and other characters that may be difficult for a non-technical human reader to understand.

### SUMMARY OF THE INVENTION

The present invention recognizes that human readers are often less concerned with the network location of a resource than with a mechanism to access the resource. In addition, the present invention appreciates that web pages typically are assigned titles that are more readily comprehensible by human readers than URLs. Accordingly, the present invention appreciates that the use of web page titles in lieu of URLs would enhance the readability of documents while still permitting user access to the referenced network resource.

In view of the foregoing, a method, system, and computer program product for substituting a textual string for a uniform resource locator (URL) in the text of a document are disclosed. In one embodiment, a method of data processing includes detecting insertion of a uniform resource locator (URL) into text of a document of an application program. In response to detecting insertion of the URL, a web page corresponding to the URL is accessed, and a title of the web page is determined. The URL is then replaced with a textual string derived from the title in place of the URL in the text of the document.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary data processing system, as utilized in an embodiment of the present invention;

FIG. 2A illustrates an exemplary document created utilizing an application program and an exemplary web page displayed via a browser interface in accordance with the present invention;

FIG. 2B illustrates a second view of the exemplary document of FIG. 2A; and

FIG. 3 is a high level logical flowchart of an exemplary method of substituting a textual string for a uniform resource locator (URL) within the text of a document of an application program in accordance with one embodiment of the present invention.

### DETAILED DESCRIPTION OF AN ILLUSTRATIVE EMBODIMENT

The present invention supports the substitution of a textual string derived from a web page title in place of a uniform resource locator (URL) in the text of a document. In a preferred embodiment, the textual string is presented within the document as a clickable link, which will invoke access to the web page if selected by the user. As utilized herein, a “document” refers to a displayed data file of application program, including, but not limited to, a file of a word processing program, a spreadsheet program, an email program, or a presentation program.

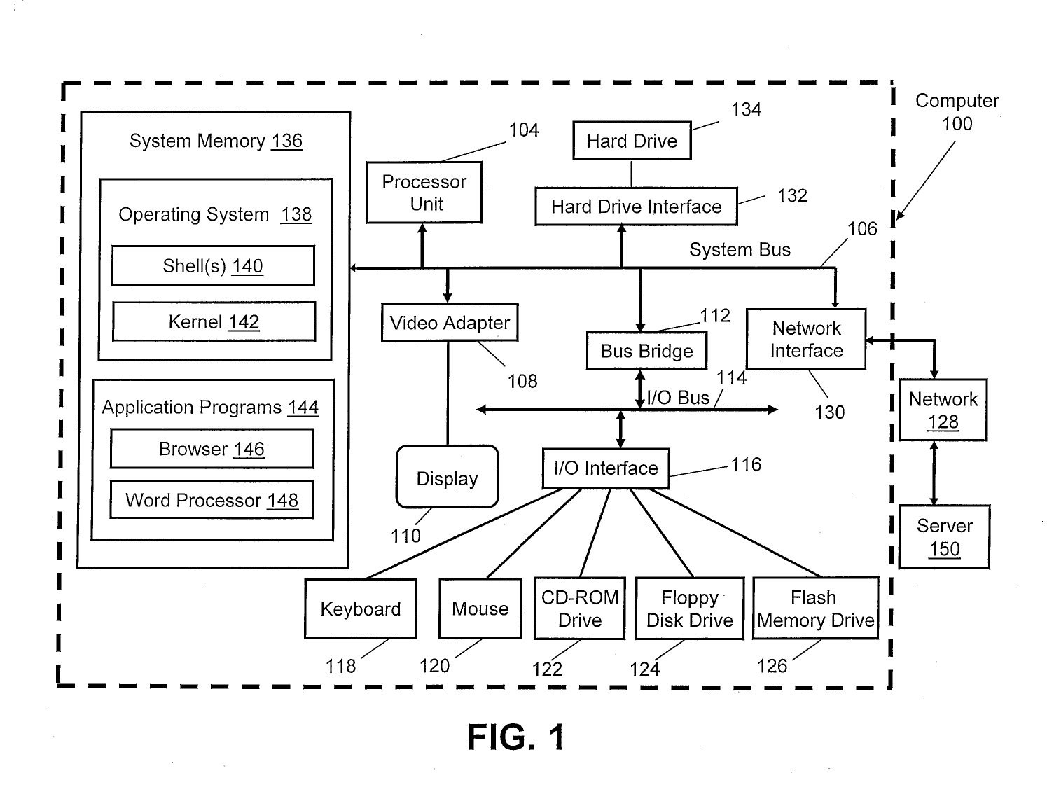

With reference now to the figures and in particular with reference to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In a preferred embodiment, hard drive 134 populates the system memory 136, which is also coupled to system bus 106. System memory is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and mouse and keyboard management.

Application programs 144 include browser 146 and word processor 148. Browser 146 includes program modules and instructions enabling a World Wide Web (WWW) client (i.e., computer 100) to send and receive network messages to the Internet. Computer 100 may utilize HyperText Transfer Protocol (HTTP) and Simple Mail Transport Protocol (SMTP) messaging to enable communication with server 150.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), etc. These and other variations are intended to be within the spirit and scope of the present invention.

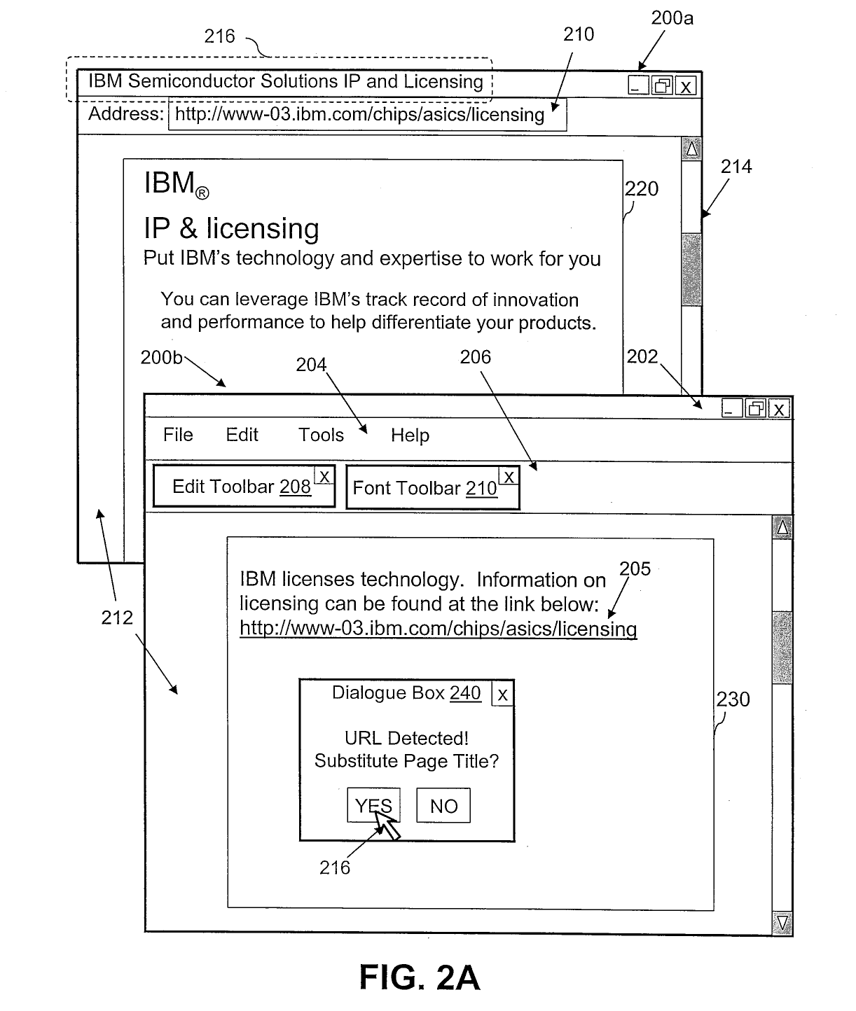

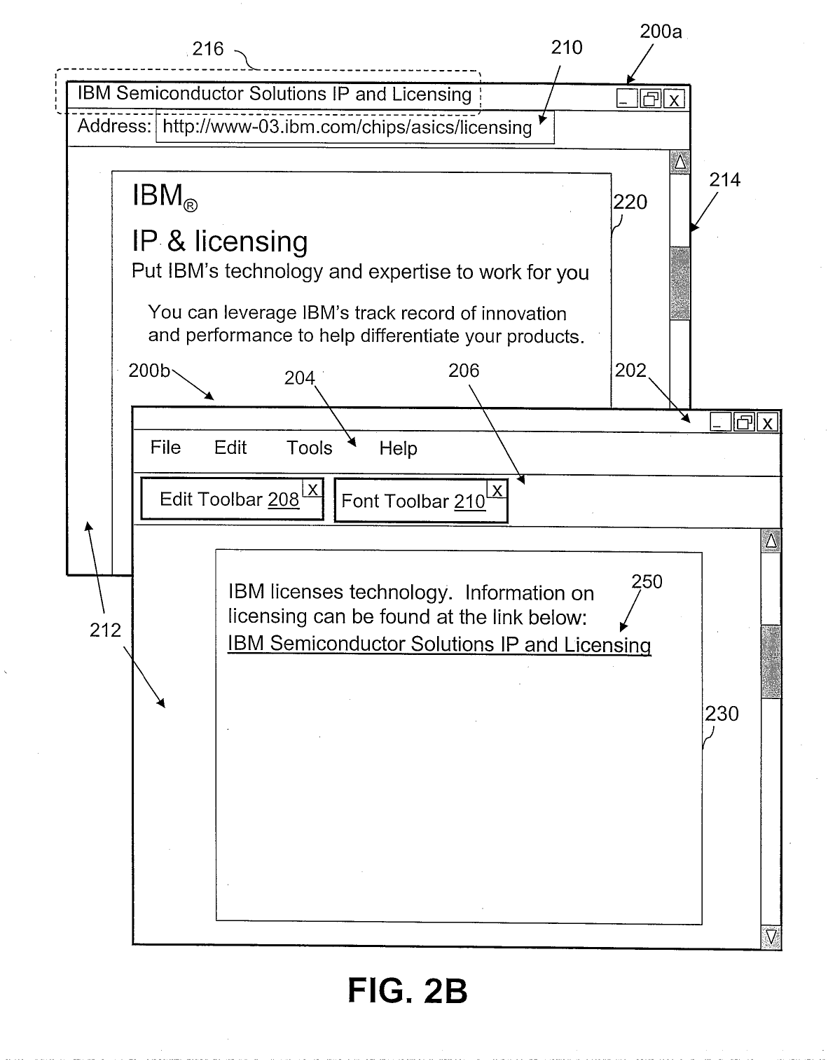

With reference now to FIGS. 2A and 2B, there are depicted exemplary document 230 of word processor 148 and exemplary web page 220 of browser 146 presented within display 110 according to an embodiment of the present invention. In the depicted embodiment, OS 138 of computer 100 supports a graphical user interface (GUI) windowing environment in which data of each instance of an application program is presented within a window 200a, 200b displayed on a simulated “desktop” (not illustrated) in display 110. Each window 200 may contain conventional GUI elements, such as a window frame 202, menu bar 204, toolbar area 206 (which in window 200b contains an edit toolbar 208 and font toolbar 210), scroll bar 214, and a data presentation region 212. Data presentation regions 212 of windows 200a and 200b display a web page 220 and document 230, respectively. A user interacts with the components of the GUI utilizing keyboard 118 and/or a graphical pointer 216 controlled by mouse 120.

Window 200a of browser 146 further includes a textual title 216 within its window frame 202 to describe the contents of the web page 220 presented within data presentation region 212. In addition, window 200a of browser 146 contains an address field 222, which indicates the URL of the web page 220 displayed within data presentation region 212.

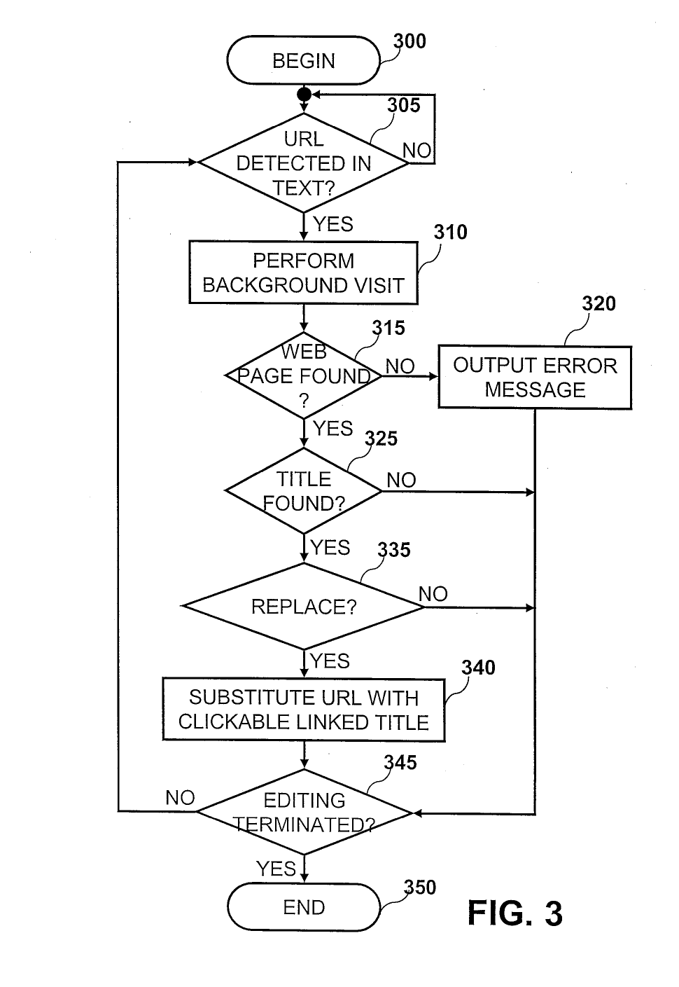

As further illustrated in FIG. 2A, window 200b of word processor 148 may have displayed in association therewith a dialogue box 240 (i.e., a floating “pop-up” window) that is presented to a user in response to the user entering into the text of document 230 a uniform resource locator (URL) 205. As described below, dialogue box 260 is one mechanism that can be employed in the process of FIG. 3 to receive a user input indicating that a text string derived from a web page title should be substituted for URL 205 within document 230.

As shown in FIG. 2B, if the user enters a “YES” command in dialogue box 260 (e.g., by pressing the “Enter” key on keyboard 118 or by “clicking” on the “YES” button utilizing graphical pointer 216), word processor 148 automatically substitutes a textual string 250 derived from title 216 for URL 205 within the text of document 230. Textual string 250 is preferably presented as a clickable link, such that the presentation of web page 220 can be invoked by utilizing graphical pointer 216 to click on textual string 250 (optionally in combination with pressing a selected key (e.g., CTRL) on keyboard 118).

Turning now to FIG. 3, there is illustrated a high level logical flowchart of an exemplary method of substituting a text string in place of a URL in the text of a document of an application program in accordance with one embodiment of the invention. The process begins at block 300, for example, in response to a user of computer 100 invoking execution of word processor 148 in order to create and/or edit a document 230. Word processor 148 then monitors entry of data into document 230 as shown at block 305 in order to detect whether a URL has been entered into the text of document 230. In order to enter a URL into the text of document 230, the user may manually type a URL 205 utilizing keyboard 118 or copy and paste URL 205 from address field 210 of browser 146. If a determination is made at block 305 that a URL has not been entered into the text of document 230, the process iterates at block 305.

In response to detection of entry of a URL 205 into the text of document 230, word processor 148 performs a background visit to the web page identified by URL 205 via network interface 130 and network 128, as shown in block 310. The background visit is preferably not visible to the user and is performed to obtain information regarding the web page, as illustrated in blocks 315-325 and discussed below. In an alternate embodiment, word processor 148 commands browser 146 to perform the background visit at block 310.

Word processor 148 then determines at block 315 whether word processor 148 and/or browser 146 were able to locate web page 220 identified by URL 205 during the background visit. If not, word processor 148 presents an error message such as “Page Not Found” at block 320. The present invention thus alerts user of typographical errors made when typing URL 205. Thereafter, the process passes to block 345, which is described below.

If, on the other hand, word processor 148 determines at block 315 that web page 220 was located during the background visit, word processor 148 determines at block 325 whether web page 220 includes title 216, for example, by determining if the HyperText Markup Language (HTML) or eXtended Markup Language (XML) defining the contents of web page 220 includes a Title tag. If web page 220 does not include title 216, the process proceeds to block 345, which is described below. If web page 220 does include title 216, word processor 148 determines whether at block 335 whether or not to replace URL 205 with a textual string derived from title 216. In the embodiment shown in FIG. 2A, the determination includes presenting a prompt to the user (e.g., by displaying dialogue box 240) and determining the user's response to the prompt. Of course, in other embodiments of the present invention, the determination depicted at block 335 can be made by reference to a predetermined user preference maintained by word processor 148 or OS 138 or by reference to a default setting of word processor 148.

In response to a determination at block 335 that a replacement of the URL is not to be performed, word processor 148 closes any related dialogue box 240, and the process proceeds to block 345, which is discussed below. If, however, a determination is made at block 335 that URL 205 is to be replaced with a textual string derived from title 215, word processor 148 automatically replaces URL 205 with textual string 250 in the text of document 200, as depicted at block 340 and in FIG. 2B. In a preferred embodiment, textual string 250 employs the initial N characters of title 216, where N is a positive integer (e.g., 50). Thus, for titles longer than N characters, title 216 is truncated to obtain textual string 250; in cases in which title 216 is less than or equal to N characters in length, textual string 250 is preferably identical to title 216.

Following block 340, word processor 148 determines at block 345 whether or not an input has been received indicating that editing of document 230 is to be terminated. For example, the input may be a close command indicating that document 230 is to be closed. Alternatively, the input may be a send command indicating that a word processing, email, presentation or spreadsheet document is to be transmitted over a network. In response to a determination at block 345 that editing of the document is terminated, the process shown in FIG. 3 terminates at block 350. If, however, a determination is made at block 345 that editing is not terminated, the process returns to block 305, which has been described.

The present invention thus enables word processor 148, an email program, or any similar application program 144 to automatically replace one or more URLs with one or more clickable linked textual strings corresponding to the titles of the web pages identified by the URLs.

While the invention has been particularly shown and described with reference to a preferred embodiment, it will be understood by those skilled in the art that various changes in form and detail may be made therein without departing from the spirit and scope of the invention. For example, although an illustrative embodiment of the present invention has been described in the context of a fully functional computer system with installed software, those skilled in the art will appreciate that aspects of the present invention are capable of being distributed as a program product including program code, and that an illustrative embodiment of the present invention applies equally regardless of the particular type of computer readable media used to actually carry out the distribution. Examples of computer readable media include recordable type media such as thumb drives, floppy disks, hard drives, CD ROMs, DVDs, and transmission type media such as digital and analog communication links.

What is claimed is:

1. A method of data processing, comprising:
detecting insertion of a uniform resource locator (URL) into text of a document of an application program;
in response to detecting insertion of the URL, accessing a web page corresponding to said URL;
determining a title of said web page; and
replacing said URL with a textual string derived from the title in place of the URL in the text of the document.

2. The method of claim 1, wherein said accessing comprises accessing the web page without presenting the web page in a display device.

3. The method of claim 1, wherein:
the URL is a first URL and the web page is a first web page;
said method further comprises:
in response to detecting insertion of a second URL, attempting an access to a second web page identified by the second URL; and
if the attempted access is unsuccessful, presenting an output indicating that said URL is invalid.

4. The method of claim 1, and further comprising performing the replacing step only in response to receipt of a user input approving the replacing.

5. The method of claim 4, and further comprising presenting a prompt to request user approval of the replacing.

6. The method of claim 1, wherein the replacing comprises replacing said URL with a textual string presented as a selectable link that, when selected by a user, invokes access to the web page.

7. A data processing system comprising:
a processor unit;
data storage communicatively connected to said processor; and
program code within the data storage that when processed by the processor unit causes the data processing system to perform a method including the following steps:
detecting insertion of a uniform resource locator (URL) into text of a document of an application program;
in response to detecting insertion of the URL, accessing a web page corresponding to said URL;
determining a title of said web page; and
replacing said URL with a textual string derived from the title in place of the URL in the text of the document.

8. The data processing system of claim 7, and further comprising a display device, wherein said accessing comprises accessing the web page without presenting the web page in a display device.

9. The data processing system of claim 7, wherein:
the URL is a first URL and the web page is a first web page;
said method further comprises:
in response to detecting insertion of a second URL, attempting an access to a second web page identified by the second URL; and
if the attempted access is unsuccessful, presenting an output indicating that said URL is invalid.

10. The data processing system of claim 7, the method further comprising performing the replacing step only in response to receipt of a user input approving the replacing.

11. The data processing system of claim 10, the method further comprising presenting a prompt to request user approval of the replacing.

12. The data processing system of claim 7, wherein the replacing comprises replacing said URL with a textual string presented as a selectable link that, when selected by a user, invokes access to the web page.

13. A computer program product comprising:
a tangible computer readable medium; and
program code on the tangible computer readable medium that that when processed by a computer performs a method including the following steps:
detecting insertion of a uniform resource locator (URL) into text of a document of an application program;
in response to detecting insertion of the URL, accessing a web page corresponding to said URL;
determining a title of said web page; and
replacing said URL with a textual string derived from the title in place of the URL in the text of the document.

14. The computer program product of claim 13, wherein the computer includes a display device, and wherein said accessing comprises accessing the web page without presenting the web page in a display device.

15. The computer program product of claim 13, wherein:
the URL is a first URL and the web page is a first web page;
said method further comprises:
in response to detecting insertion of a second URL, attempting an access to a second web page identified by the second URL; and
if the attempted access is unsuccessful, presenting an output indicating that said URL is invalid.

16. The computer program product of claim 13, the method further comprising performing the replacing step only in response to receipt of a user input approving the replacing.

17. The computer program product of claim 16, the method further comprising presenting a prompt to request user approval of the replacing.

18. The computer program product of claim 13, wherein the replacing comprises replacing said URL with a textual string presented as a selectable link that, when selected by a user, invokes access to the web page.
